(19) United States
(12) Patent Application Publication
(10) Pub. No.: US 2018/0268817 A1
(43) Pub. Date: Sep. 20, 2018

(54) INFORMATION PROCESSING APPARATUS, INFORMATION PROCESSING METHOD, AND COMPUTER PROGRAM PRODUCT

(71) Applicant: Yoshiko AONO, Kanagawa (JP)

(72) Inventor: Yoshiko AONO, Kanagawa (JP)

(73) Assignee: Ricoh Company, Ltd., Tokyo (JP)

(21) Appl. No.: 15/907,350

(22) Filed: Feb. 28, 2018

(30) Foreign Application Priority Data
Mar. 17, 2017 (JP) 2017-053017
Dec. 27, 2017 (JP) 2017-252637

(51) Int. Cl. G10L 15/22

(52) U.S. Cl. CPC G10L 15/22; G10L 2015/223

(57) ABSTRACT

An information processing apparatus is communicable with a speech recognition apparatus via a network includes circuitry. The circuitry implements a speech recognition function that performs speech recognition on audio data collected by an audio collecting device. The circuitry selects, as a destination to which the audio data is to be output, one of the speech recognition apparatus and the speech recognition function implemented by the circuitry, based on a state of communication between the information processing apparatus and an external system connected to the information processing apparatus via the network.

### CROSS-REFERENCE TO RELATED APPLICATIONS

This patent application is based on and claims priority pursuant to 35 U.S.C. § 119(a) to Japanese Patent Application Nos. 2017-053017, filed on Mar. 17, 2017, and 2017-252637, filed on Dec. 27, 2017 in the Japan Patent Office, the entire disclosures of which are hereby incorporated by reference herein.

### BACKGROUND

### Technical Field

The present disclosure relates to an information processing apparatus, an information processing method, and a computer program product.

### Description of the Related Art

In recent years, voice command operation that operates devices by means of human voice is in widespread use, due to the development of speech recognition technology of natural language and improvement of services called artificial intelligence. In this voice command operation, commands are executed in two different ways. In one way, a device as an operation target itself performs speech recognition to execute a command. In the other way, the device as an operation target transmits speech data to a cloud service, and performs a command, which is a result of the speech recognition performed by the cloud service.

The cloud service receives speech data collected by the device via the Internet, and sends back a command recognized by speech recognition to the device. For this reason, a time period from when the device as an operation target acquires speech data until when the device executes a command largely depends on the bandwidth of a network.

### SUMMARY

An information processing apparatus is communicable with a speech recognition apparatus via a network includes circuitry. The circuitry implements a speech recognition function that performs speech recognition on audio data collected by an audio collecting device. The circuitry selects, as a destination to which the audio data is to be output, one of the speech recognition apparatus and the speech recognition function implemented by the circuitry, based on a state of communication between the information processing apparatus and an external system connected to the information processing apparatus via the network.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is an illustration for explaining an overview of an information processing system according to a first embodiment of the present disclosure;

FIG. 2 is a schematic view illustrating an example of a system configuration of the information processing system according to the first embodiment of the present disclosure;

FIG. 3 is a block diagram illustrating an example hardware configuration of an electronic whiteboard according to the first embodiment of the present disclosure;

FIG. 4 is a block diagram illustrating an example hardware configuration of a smart speaker according to the first embodiment of the present disclosure;

FIG. 5 is a block diagram illustrating an example hardware configuration of a server apparatus according to the first embodiment of the present disclosure;

FIG. 6 is a block diagram illustrating functions of each apparatus included in the information processing system according to the first embodiment of the present disclosure;

FIG. 7 is a diagram illustrating an example of a command database according to the first embodiment of the present disclosure;

FIG. 8 is an illustration for explaining a delay determination table according to the first embodiment of the present disclosure;

FIGS. 9A and 9B are a sequence diagram illustrating an operation performed by the information processing system according to the first embodiment of the present disclosure;

FIG. 10 is a schematic view illustrating an example of a system configuration of an information processing system according to a second embodiment of the present disclosure;

FIG. 11 is a block diagram illustrating functions of each apparatus included in the information processing system according to the second embodiment of the present disclosure;

FIG. 12 illustrates an example of a delay determination table according to the second embodiment of the present disclosure;

FIG. 13 illustrates an example of a priority table according to the second embodiment of the present disclosure, and

FIG. 14 is a flowchart illustrating steps in an operation performed by an output destination selector according to the second embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the multiple forms as well, unless the context clearly indicates otherwise.

Referring to the drawings, embodiments of the present invention are described.

### Embodiment 1

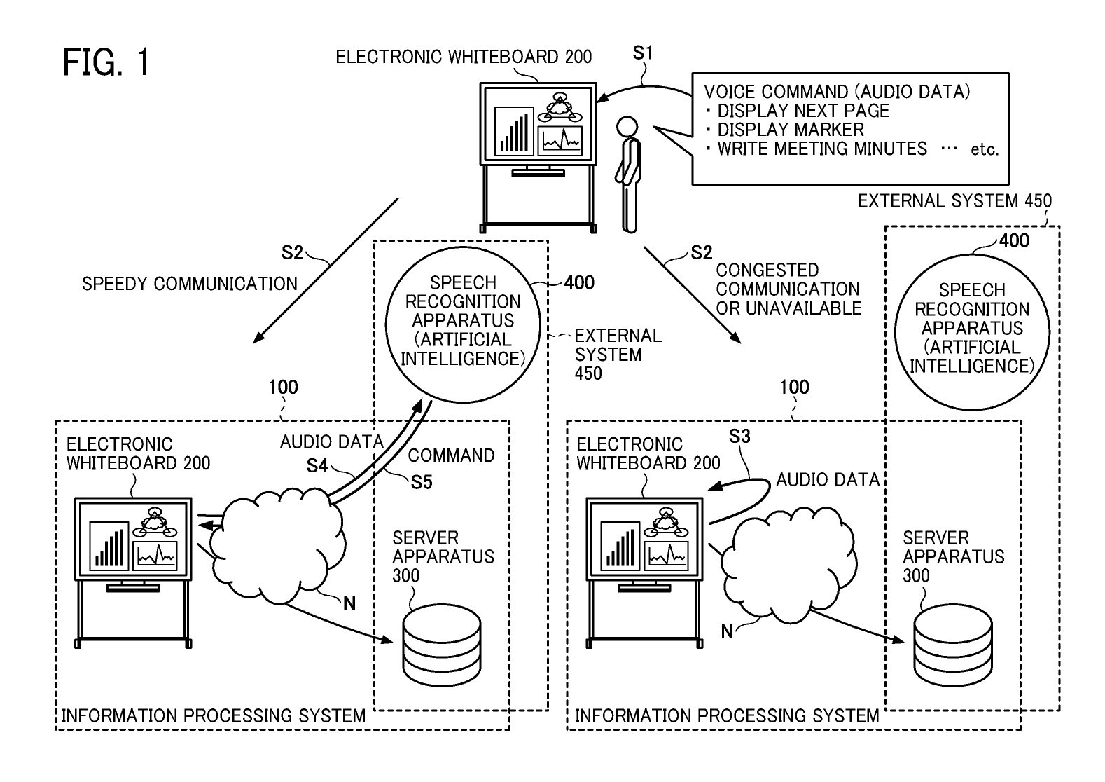

Hereinafter, a description is given of a first embodiment of the present disclosure with reference drawings. FIG. 1 is an illustration for explaining an overview of an information processing system 100 according to a first embodiment of the present disclosure.

The information processing system 100 according to the present embodiment includes an electronic whiteboard 200 and a server apparatus 300. In the information processing system 100, the electronic whiteboard 200 and the server apparatus 300 are connected to each other via a network N. In addition, the information processing system 100 according to the present embodiment is connected to a speech recognition apparatus 400 that converts audio data into text data, via the network N.

The speech recognition apparatus 400 according to the present embodiment is, for example, a service that is provided by artificial intelligence. The speech recognition apparatus 400 converts the received audio data into text data by a speech recognition function, and transmits the text data to the electronic whiteboard 200 and the server apparatus 300.

Further, the electronic whiteboard 200 according to the present embodiment selects a destination to which the audio data is to be output depending on a state of communication between the electronic whiteboard 200 and an external system 450 that includes the server apparatus 300 and the speech recognition apparatus 400. Hereinafter, a description is given of an example in which the electronic whiteboard 200 selects the destination to which the audio data is to be output depending on the state of communication between the electronic whiteboard 200 and the server apparatus 300 included in the external system 450.

The electronic whiteboard 200 according to the present embodiment includes an audio collecting device such as a microphone. After acquiring audio data by the audio collecting device (S1), the electronic whiteboard 200 determines whether to acquire a command by transmitting the audio data to the speech recognition apparatus 400, or to acquire a command by a speech recognition function of the electronic whiteboard 200 itself, depending on the state of communication between the electronic whiteboard 200 itself and the server apparatus 300 (external apparatus) (S2).

More specifically, in step S2, when a period of time for communication between the electronic whiteboard 200 and the server apparatus 300 (external apparatus) indicates a predetermined pattern, the electronic whiteboard 200 determines that the command is to be acquired by the speech recognition function of the electronic whiteboard 200 itself. Based on this determination, instead of transmitting the audio data to the speech recognition apparatus 400, the electronic whiteboard 200 acquires the command by the speech recognition function of the electronic whiteboard 200 itself (S3).

In this embodiment, examples of a case where the period of time for the communication indicates the predetermined pattern include a case where the network N used by the electronic whiteboard 200 for connection with the external system 450 is congested and a case where communication cannot be performed.

In addition, in step S2, when the period of time for communication between the electronic whiteboard 200 and the server apparatus 300 does not indicate the predetermined pattern, the electronic whiteboard 200 determines to transmit the audio data to the speech recognition apparatus 400 to acquire the command. Based on this determination, the electronic whiteboard 200 transmits audio data to the speech recognition apparatus 400 (S4), and acquires a command from the speech recognition apparatus 400 (S5).

In this embodiment, examples of the case where the period of time for communication does not indicate the predetermined pattern include a case where the network N used by the electronic whiteboard 200 for connection with the external system 450 is not congested, and speedy communication can be performed.

As described above, in the information processing system 100 according to the present embodiment, a destination to which audio data is to be output is determined based on the state of communication between the electronic whiteboard 200 and the external system 450. This improves responsiveness to voice command operation.

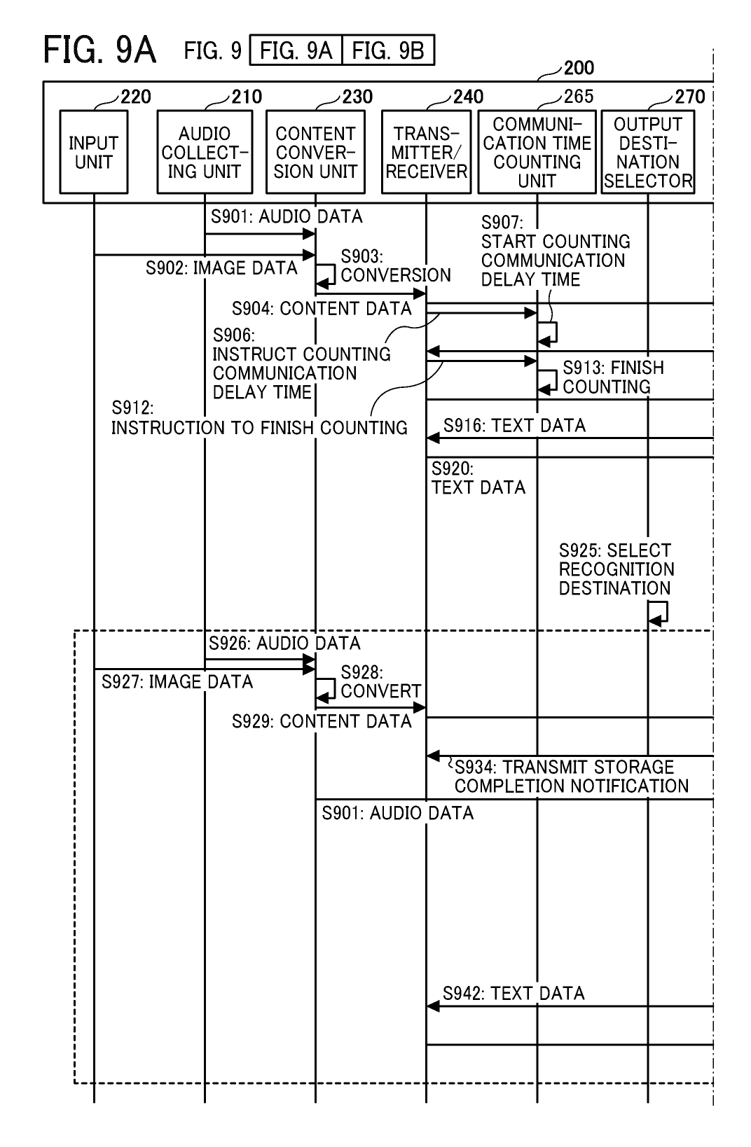

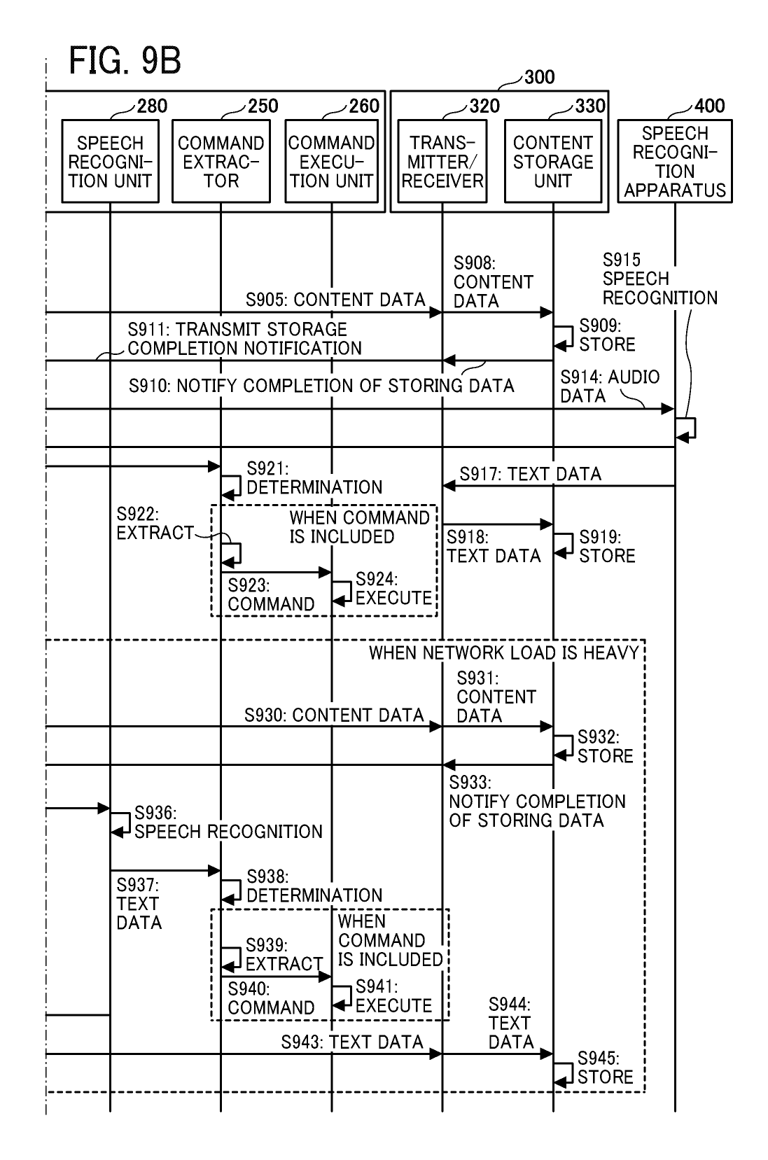

A detailed description is given later of steps S1 to S5 in FIG. 1, with reference to FIGS. 9A and 9B.

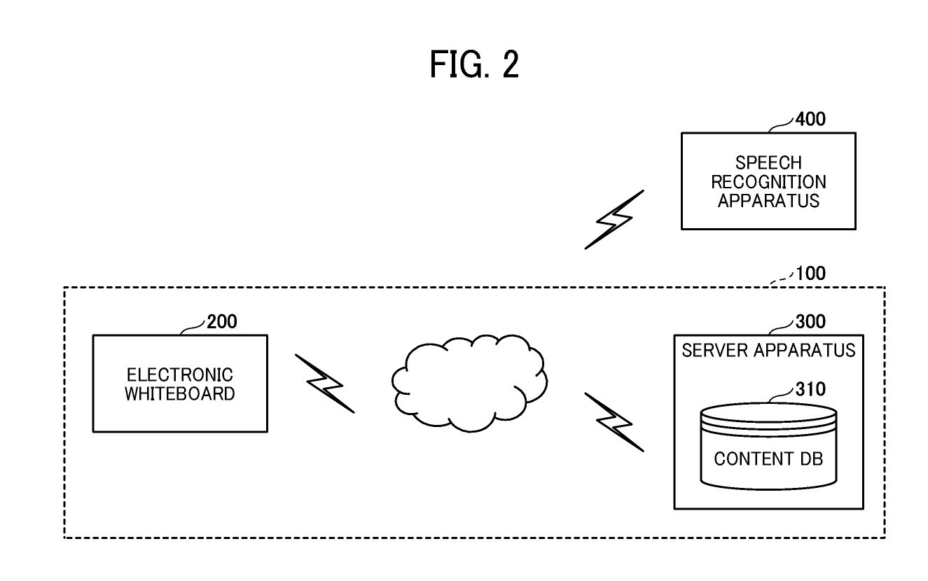

FIG. 2 is a schematic view illustrating an example of a system configuration of the information processing system 100 according to this first embodiment.

In the information processing system 100 according to the present embodiment, the electronic whiteboard 200 transmits stroke information indicating handwritten characters and drawn images, image data obtained by capturing a screen of the electronic whiteboard 200, etc., to the server apparatus 300. Further, the electronic whiteboard 200 according to the present embodiment includes an audio collecting device such as a microphone, and transmits audio data collected by the audio collecting device to the server apparatus 300 and the speech recognition apparatus 400.

The audio data according to the present embodiment is data obtained by digitizing a waveform indicating all sounds collected by the audio collecting device. In other words, in the present embodiment, speech data indicating the voice of a person who speaks near the electronic whiteboard 200 is a part of the audio data.

The server apparatus 300 according to the present embodiment stores the received stroke information, image data, audio data, etc. In addition, the server apparatus 300 according to the present embodiment stores the text data transmitted from the speech recognition apparatus 400 in association with the audio data.

Further, for example, when the electronic whiteboard 200 is used at a certain meeting, the server apparatus 300 may store a name of the meeting, the stroke information, image data and audio data acquired during the meeting, and the text data converted from the audio data in association with each other. In other words, in the server apparatus 300, various types of data acquired from the electronic whiteboard 200 may be stored for each conference.

Furthermore, the electronic whiteboard 200 according to the present embodiment determines the congestion state of the network N. When the network N is congested, the electronic whiteboard 200 switches a device that is to perform speech recognition to the electronic whiteboard 200 itself from the speech recognition apparatus 400. Thus, the electronic whiteboard 200 performs speech recognition by itself, without transmitting the audio data to the outside. In other words, the electronic whiteboard 200 determines that the network N is congested when a period of time for communication between the electronic whiteboard 200 and the external system 450 via the network N satisfies a predetermined condition. This predetermined condition may be set in advance.

In the following description, the period of time for communication between the electronic whiteboard 200 and the external system 450 via the network N is called a communication delay time. In other words, the communication delay time is a time from when the electronic whiteboard 200 transmits a signal to the external system 450 via the network N until when the electronic whiteboard 200 receives a response from the external system 450. The external system 450 that communicates with the electronic whiteboard 200 via the network N includes the server apparatus 300 (external apparatus) and the speech recognition apparatus 400.

By contrast, when the network N is not congested, the electronic whiteboard 200 according to the present embodiment transmits audio data to the speech recognition apparatus 400 to enable the speech recognition apparatus 400 to perform speech recognition. In other words, when the communication delay time does not satisfy the predetermined condition, the electronic whiteboard 200 determines that the network N is not congested.

In this embodiment, as described above, by switching a destination that performs speech recognition, responsiveness by the electronic whiteboard 200 to an operation instruction (command) by voice is improved.

Although in FIG. 1, the electronic whiteboard 200 implements a device controlled by means of voice, an electronic whiteboard is just an example. In the information processing system 100 according to the present embodiment, any other suitable apparatus may be used as a device controlled by voice, provided that it has an audio collecting device and a speech recognition function, and is capable of communicating with the speech recognition apparatus 400. For example, examples of the device controlled by means of human voice according to the present embodiment include a general-purpose computer, a tablet terminal, and a smartphone. In addition, the present embodiment can be applied to other various electronic devices.

In the following description, various data transmitted from the electronic whiteboard 200 to the server apparatus 300 is referred to as content data. In other words, the content data according to the present embodiment includes any one or any combination of audio data, image data, video data and stroke information, etc.

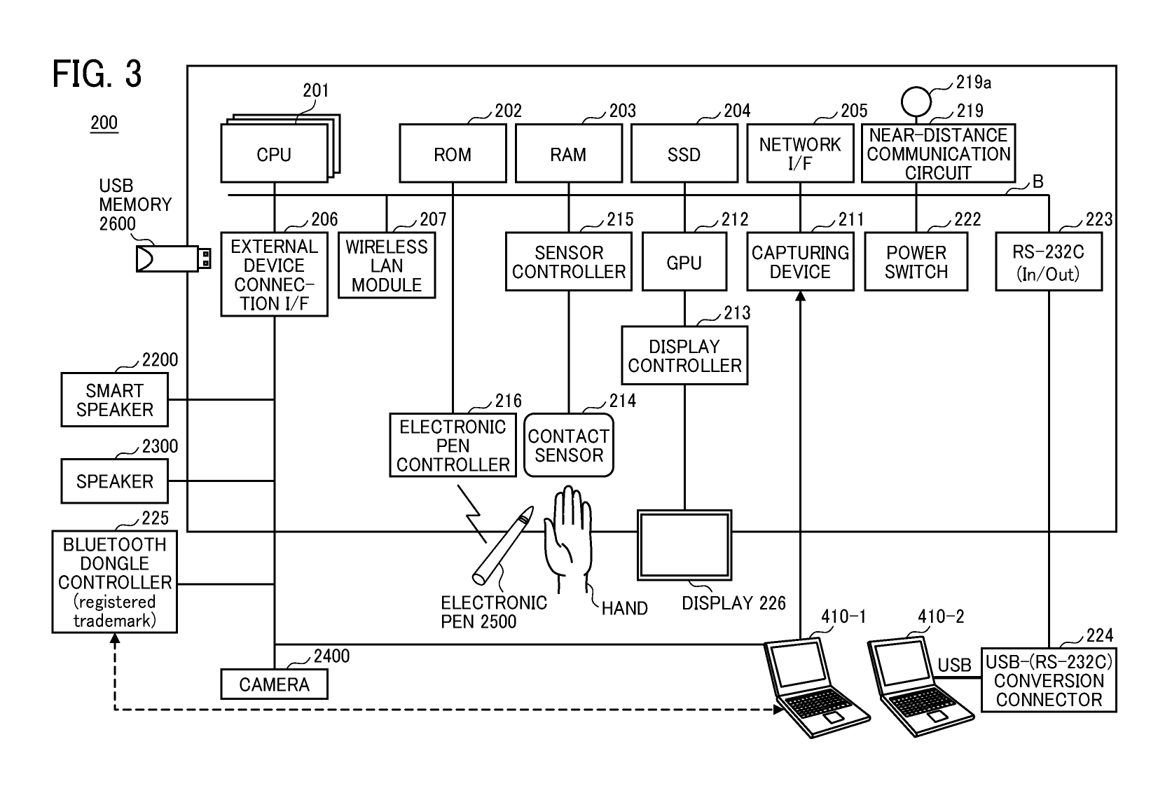

Hereinafter, a description is given of each apparatus constituted as a part of the information processing system 100 according to the present embodiment. FIG. 3 is a block diagram illustrating an example hardware configuration of the electronic whiteboard 200 according to the first embodiment.

As illustrated in FIG. 3, the electronic whiteboard 200 is an information processing apparatus including a central processing unit (CPU) 201, a read only memory (ROM) 202, a random access memory (RAM) 203, a solid state drive (SSD) 204, a network interface (I/F) 205, an external device connection interface (I/F) 206, and a wireless local area network (LAN) module 207.

The CPU 201 controls entire operation of the electronic whiteboard 200. The CPU 201 may include a plurality of CPUs, for example.

The ROM 202 stores programs such as an Initial Program Loader (IPL) to boot the CPU 201. The RAM 203 is used as a work area for the CPU 201. The SSD 204 stores various data such as a control program for the electronic whiteboard 200. The network I/F 205 controls communication with a communication network. The external device connection I/F 206 controls communication with a universal serial bus (USB) memory 2600, and external devices such as a camera 2400, a speaker 2300, and a smart speaker 2200. The wireless LAN module 207 connects the electronic whiteboard 200 to a network by a wireless LAN.

The electronic whiteboard 200 further includes a capturing device 211, a graphics processing unit (GPU) 212, a display controller 213, a contact sensor 214, a sensor controller 215, an electronic pen controller 216, a near-distance communication circuit 219, an antenna 219a for the near-distance communication circuit 219, and a power switch 222.

The capturing device 211 causes a display of a PC 410-1 to display a still image or a video image based on image data. The GPU 212 is a semiconductor chip dedicated to processing a graphical image. The display controller 213 controls display of an image input from the GPU 212 for output through a display 226 (display device). The contact sensor 214 detects a touch onto the display 226 with an electronic pen 2500 or a user's hand H.

The sensor controller 215 controls operation of the contact sensor 214. The contact sensor 214 performs input of coordinates and detection of coordinates using an infrared blocking system. More specifically, the display 226 is provided with two light receiving elements disposed on both upper side ends of the display 226, and a reflector frame disposed at the sides of the display 226. The light receiving elements emit a plurality of infrared rays in parallel to a surface of the display 226. The light receiving elements receive lights passing in the direction that is the same as an optical path of the emitted infrared rays, which are reflected by the reflector frame. The contact sensor 214 outputs an identifier (ID) of the infrared ray that is blocked by an object after being emitted from the light receiving elements, to the sensor controller 215. Based on the ID of the infrared ray, the sensor controller 215 detects a specific coordinate that is touched by the object.

The electronic pen controller 216 communicates with the electronic pen 2500 to detect a touch by the tip or bottom of the electronic pen 2500 to the display 226. The near-distance communication circuit 219 is a communication circuit that communicates in compliance with the NFC, the Bluetooth (registered trademark) and the like.

The power switch 222 is a switch that turns on or off the power of the electronic whiteboard 200.

The electronic whiteboard 200 further includes a bus line B. The bus line B is an address bus or a data bus, which electrically connects the elements in FIG. 3 such as the CPU 201.

The electronic whiteboard 200 further includes an RS-232C port 223, a conversion connector 224, and a Bluetooth controller 225.

The RS-232C port 223 is connected to the bus line B, and connects a PC 410-2 and the like to the CPU 201 and the like. The conversion connector 224 is a connector for connecting the electronic whiteboard 200 to a USB port of the PC 410-2.

The Bluetooth controller 225 is, for example, a controller to enable the electronic whiteboard 200 to communicate with the PC 410-1, etc., using the Bluetooth.

The contact sensor 214 is not limited to the infrared blocking system type, and may be a different type of detector, such as a capacitance touch panel that identifies the contact position by detecting a change in capacitance, a resistance film touch panel that identifies the contact position by detecting a change in voltage of two opposed resistance films, or an electromagnetic induction touch panel that identifies the contact position by detecting electromagnetic induction caused by contact of an object to a display. In addition or in alternative to detecting a touch by the tip or bottom of the electronic pen 2500, the electronic pen controller 216 may also detect a touch by another part of the electronic pen 2500, such as a part held by a user's hand.

The electronic whiteboard 200 according to the present embodiment implements processes as described later with the hardware configuration as illustrated in FIG. 3.

Further, the smart speaker 2200 according to the present embodiment has, for example, a function of connecting to a network and a microphone. The smart speaker 2200 is one example of an audio collecting device. For example, artificial intelligence is installed on the smart speaker 2200 according to the present embodiment. The smart speaker 2200 implements various function by performing communication in compliance with the standard such as Wi-Fi and Bluetooth, in addition to collecting audio data and reproducing audio data.

In the present embodiment, for example, a command to the electronic whiteboard 200 may be acquired from audio data collected by the smart speaker 2200. Although in an example of FIG. 3, the smart speaker 2200 implements an audio collecting device, the smart speaker 2200 is just an example. For example, the electronic whiteboard 200 may have a general-purpose microphone, instead of the smart speaker 2200.

Further, the electronic whiteboard 200 may be wirelessly connected to the smart speaker 2200 via the wireless LAN module 207 and a network connecting function of the smart speaker 2200. Hereinafter, a description is given of a hardware configuration of the smart speaker 2200 according to the present embodiment.

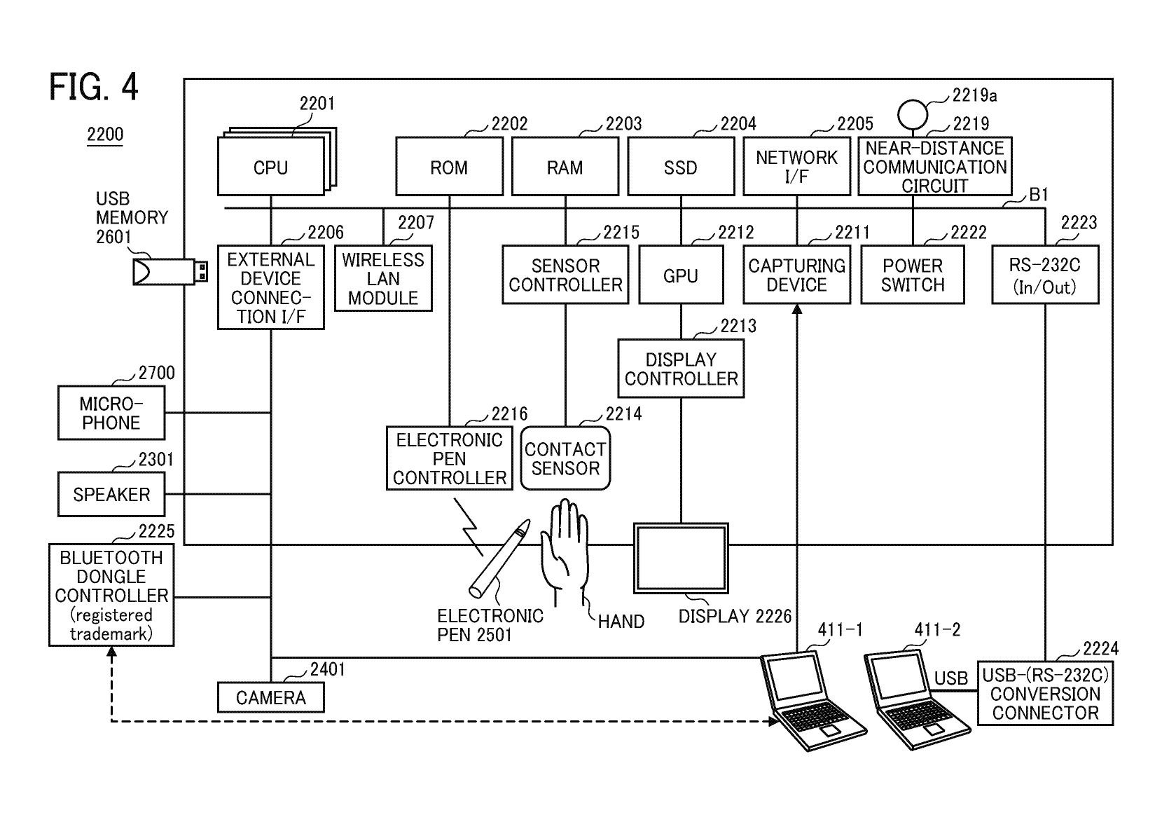

FIG. 4 is a block diagram illustrating an example hardware configuration of the smart speaker 2200 according to the first embodiment.

The smart speaker 2200 is an information terminal including a CPU 2201, a ROM 2202, a RAM 2203, an SSD 2204, a network I/F 2205, an external device connection I/F 2206, and a wireless LAN module 2207.

The CPU 2201 controls entire operation of the smart speaker 2200. The CPU 2201 may include a plurality of CPUs, for example.

The ROM 2202 stores programs such as an IPL to boot the CPU 2201. The RAM 2203 is used as a work area for the CPU 2201. The SSD 2204 stores various data such as a control program for the smart speaker 2200. The network I/F 2205 controls communication with a communication network. The external device connection I/F 2206 controls communication with a USB memory 2601, and external devices such as a camera 2401, a speaker 2301, a microphone 2700, etc. The wireless LAN module 2207 connects the smart speaker 2200 to a network by a wireless LAN.

The smart speaker 2200 further includes a capturing device 2211, a GPU 2212, a display controller 2213, a contact sensor 2214, a sensor controller 2215, an electronic pen controller 2216, a near-distance communication circuit 2219, an antenna 2219a for the near-distance communication circuit 2219, and a power switch 2222.

The capturing device 2211 causes a display of a PC 411-1 to display a still image or a video image based on image data. The GPU 2212 is a semiconductor chip dedicated to processing a graphical image. The display controller 2213 controls and manages display of an image input from the GPU 2212 for output through a display 2226 (display device). The contact sensor 2214 detects a touch onto the display 2226 with an electronic pen 2501 or a user's hand H.

The sensor controller 2215 controls operation of the contact sensor 2214. The contact sensor 2214 performs input of coordinates and detection of coordinates using an infrared blocking system. More specifically, the display 2226 is provided with two light receiving elements disposed on both upper side ends of the display 2226, and a reflector frame disposed at the sides of the display 2226. The light receiving elements emit a plurality of infrared rays in parallel to a surface of the display 2226. The light receiving elements receive lights passing in the direction that is the same as an optical path of the emitted infrared rays, which are reflected by the reflector frame. The contact sensor 2214 outputs an ID of the infrared ray that is blocked by an object after being emitted from the two light receiving elements, to the sensor controller 2215. Based on the ID of the infrared ray, the sensor controller 2215 detects a specific coordinate that is touched by the object.

The electronic pen controller 2216 communicates with the electronic pen 2501 to detect a touch by the tip or bottom of the electronic pen 2501 to the display 2226. The near-distance communication circuit 2219 is a communication circuit that communicates in compliance with the NFC, the Bluetooth (registered trademark) and the like.

The power switch 2222 is a switch that turns on or off the power of the smart speaker 2200.

The smart speaker 2200 further includes a bus line B1. The bus line B1 is an address bus or a data bus, which electrically connects the elements in FIG. 4 such as the CPU 2201.

A Bluetooth controller 2225 is, for example, a controller to enable the smart speaker 2200 to communicate with the PC 411-1, etc., using the Bluetooth.

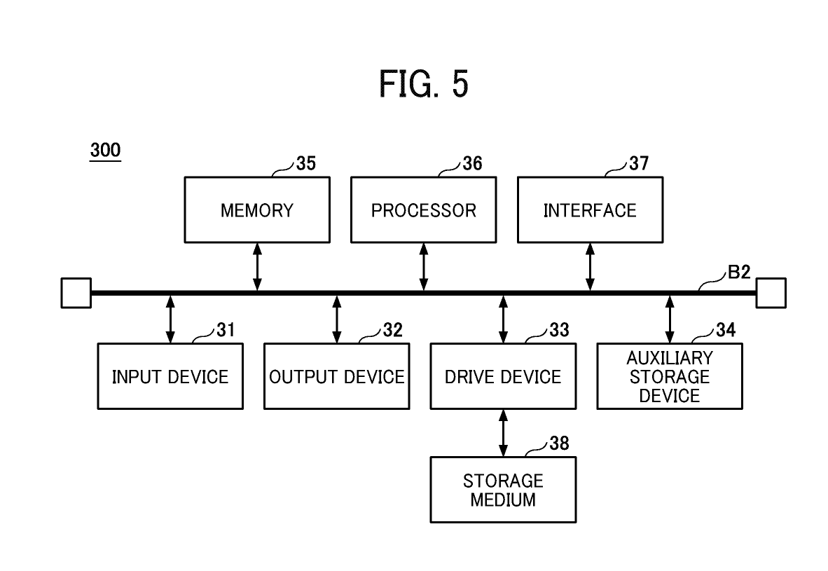

Hereinafter, a description is given of a hardware configuration of the server apparatus 300 according to this embodiment with reference to FIG. 5. FIG. 5 is a block diagram illustrating an example hardware configuration of the server apparatus 300 according to the first embodiment.

The server apparatus 300 (external apparatus) according to the present embodiment is implemented by, for example, a general-purpose computer. The server apparatus 300 includes an input device 31, an output device 32, a drive device 33, an auxiliary storage device 34, a memory 35, a processor 36, and an interface 37, which are connected to each other via a bus line B2.

The input device 31 is used for inputting various kinds of information. Examples of the input device 31 include a mouse and a keyboard. The output device 32 is used for displaying (outputting) various signals. Examples of the output device include a display. The interface 37 includes a modem, a LAN card, etc., and is used for connection to a network.

An information processing program is at least a part of various programs for controlling the server apparatus 300. The information processing program is distributed, being stored in a storage medium 38. Alternatively, the information processing program is downloaded via a network, for example. The storage medium 38 storing the information processing program is implemented by various types of storage medium such as a storage medium that optically, electrically or magnetically records information, such as a CD-ROM, a flexible disk, or a magneto-optical disk, or a semiconductor memory that electrically records information, such as a ROM and a flash memory.

When the storage medium 38 storing the information processing program is set in the drive device 33, the information processing program is installed in the auxiliary storage device 34 from the storage medium 38 via the drive device 33. A communication program downloaded from the network is installed in the auxiliary storage device 34 via the interface 37.

The auxiliary storage device 34 stores the installed information processing program, and further stores necessary files, data, etc. The memory 35 reads out the information processing program from the auxiliary storage device 34 when the computer is started up and the read-out information processing program. The processor 36, such as a central processing unit (CPU), implements various processes as described later in according to the programs stored in the memory 35.

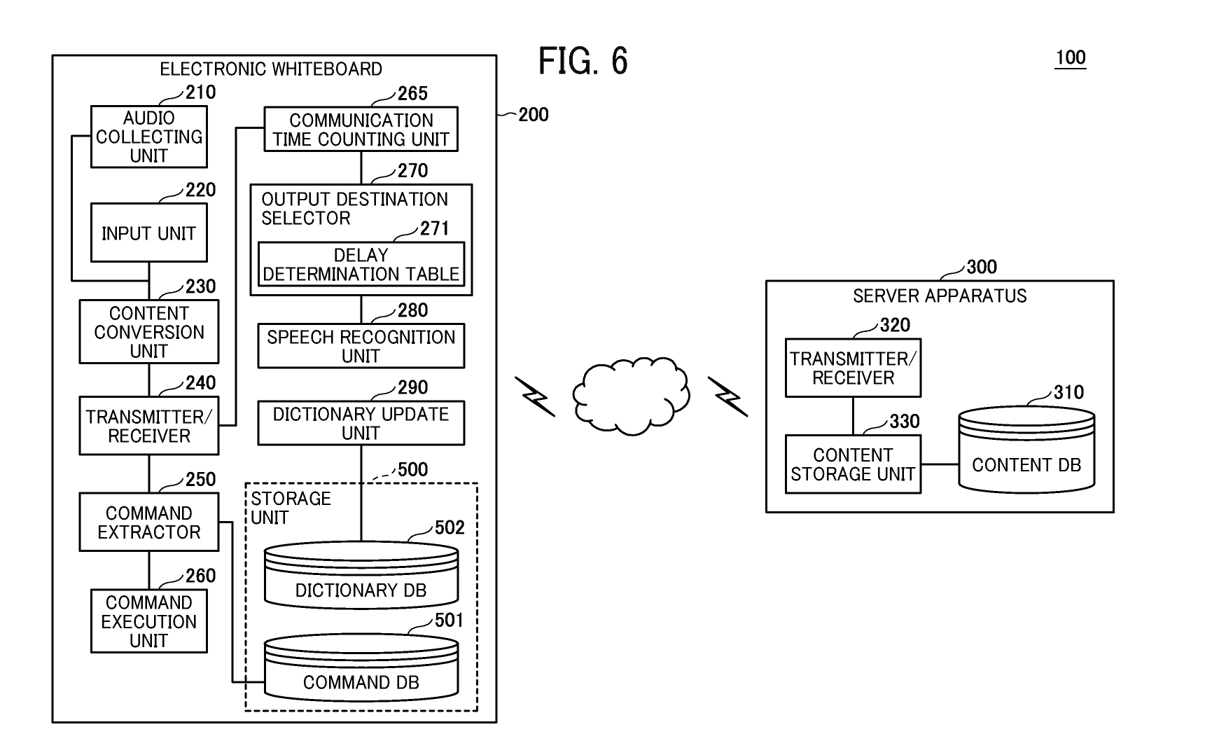

Hereinafter, a description is given of functions of each apparatus included in the information processing system 100 with reference to FIG. 6. FIG. 6 is a block diagram illustrating functions of each apparatus included in the information processing system 100.

First, a description is given of functions of the electronic whiteboard 200. The functions of the electronic whiteboard 200 described hereinafter are implemented by the CPU 27 executing the program loaded from the RAM 26, etc.

The electronic whiteboard 200 according to the present embodiment includes an audio collecting unit 210, an input unit 220, a content conversion unit 230, a transmitter/receiver 240, a command extractor 250, a command execution unit 260, a communication time counting unit 265, an output destination selector 270, a speech recognition unit 280, and a dictionary update unit 290. The CPU 201 reads out and executes the program from the ROM 202, etc., to implement the above-described functional units.

The electronic whiteboard 200 according to the present embodiment further includes a storage unit 500. The storage unit 500 includes a command database 501 and a dictionary database 502. The storage unit 500 may be provided in a storage device such as the ROM 202 or the SSD 204 of the electronic whiteboard 200, for example.

Further, the storage unit 500 according to the present embodiment indicates a storage area in the storage device, and the storage unit 500 may be implemented by a plurality of storage devices.

The command database 501 according to the present embodiment stores a recognition result of audio data and an operation content of the electronic whiteboard 200 in association with each other. A detailed description is given later of details of the command database 501.

The dictionary database 502 according to the present embodiment is referred to by the speech recognition unit 280 for speech recognition.

The audio collecting unit 210 obtains audio that is input to the smart speaker 2200 as audio data. The input unit 220 acquires stroke information indicating characters and images drawn by hand on the display 226 of the electronic whiteboard 200, or image data of an image displayed on the display 226. In this embodiment, the stroke information is coordinate information of a group of points that together form the trajectory of each stroke drawn by a user on the touch panel. The input unit 220 acquires video data, etc., captured by the camera 2400, for example.

The content conversion unit 230 converts the audio data, the image data, and the video data into a format suitable for storage in the server apparatus 300. More specifically, the content conversion unit 230 converts the audio data to Advanced Audio Coding (AAC) format, for example. Further, the content conversion unit 230 converts the image data or the video data to JPEG format, for example. Thus, the content conversion unit 230 according to the present embodiment compresses various data to enable the various data to be exchanged smoothly via the network N and not to put pressure on a memory capacity of the server apparatus 300. In the present embodiment, the image data includes the video data.

The transmitter/receiver 240 transmits the audio data acquired by the audio collecting unit 210 to the server apparatus 300 and the speech recognition apparatus 400. In other words, the electronic whiteboard 200 transmits the audio data to an external terminal (speech recognition apparatus 400) that is not included in the information processing system 100. In addition, the transmitter/receiver 240 transmits the image data, the video data, etc., acquired by the input unit 220 to the server apparatus 300.

The command extractor 250 refers to the command database 501 to extract commands for the electronic whiteboard 200 included in the audio data from text data received from the speech recognition apparatus 400 or text data recognized by the speech recognition unit 280.

The command execution unit 260 executes an operation indicated by a command based on the command received by the transmitter/receiver 240 from the server apparatus 300.

The communication time counting unit 265 measures the communication delay time, which is a time period from when the transmitter/receiver 240 transmits content data to the server apparatus 300 until when the transmitter/receiver 240 receives a notification that storage of the content data has been completed from the server apparatus 300. In addition, the communication time counting unit 265 according to the present embodiment may store the measured communication delay time each time the communication delay time is obtained, as information indicating the history of communication.

The output destination selector 270 selects an apparatus that is to perform speech recognition based on the communication delay time measured by the communication time counting unit 265. In other words, the output destination selector 270 selects a destination to which the audio data is to be output based on the communication delay time.

More specifically, the output destination selector 270 includes a delay determination table 271. The output destination selector 270 refers to the delay determination table 271 to determine whether the communication delay time satisfies a predetermined condition. When the communication delay time satisfies the predetermined condition, the output destination selector 270 selects the electronic whiteboard 200 as a destination apparatus to which the audio data is to output and which is to perform speech recognition. A detailed description is given later of details of the delay determination table 271.

The speech recognition unit 280 performs speech recognition on the audio data collected by the audio collecting unit 210, referring to the dictionary database 502, and outputs text data as a result of speech recognition.

The dictionary update unit 290 refers to a dictionary database of the speech recognition apparatus 400 via the network N and updates the dictionary database 502 in accordance with the dictionary database of the speech recognition apparatus 400. For example, the dictionary update unit 290 according to the present embodiment may update the dictionary database 502 at the time when the electronic whiteboard 200 is started up. In addition, the dictionary update unit 290 according to the present embodiment may update the dictionary database 502 when the electronic whiteboard 200 is not in use.

Next, a description is given of functions of the server apparatus 300. The server apparatus 300 according to the present embodiment includes a content database 310. The server apparatus 300 according to the present embodiment further includes a transmitter/receiver 320 and a content storage unit 330. Each functional unit of the server apparatus 300 according to the present embodiment is implemented by the processor 36 executing the information processing program loaded from the memory 35.

The content database 310 according to the present embodiment may be provided in the auxiliary storage device 34 of the server apparatus 300, for example.

The content database 310 stores various data (contents) received from the electronic whiteboard 200. The contents according to the present embodiment includes the audio data, the image data, and the stroke information.

The transmitter/receiver 320 according to the present embodiment exchanges data (information) with the electronic whiteboard 200. The transmitter/receiver 320 also exchanges data (information) with the speech recognition apparatus 400.

The content storage unit 330 stores the contents received from the electronic whiteboard 200 in the content database 310.

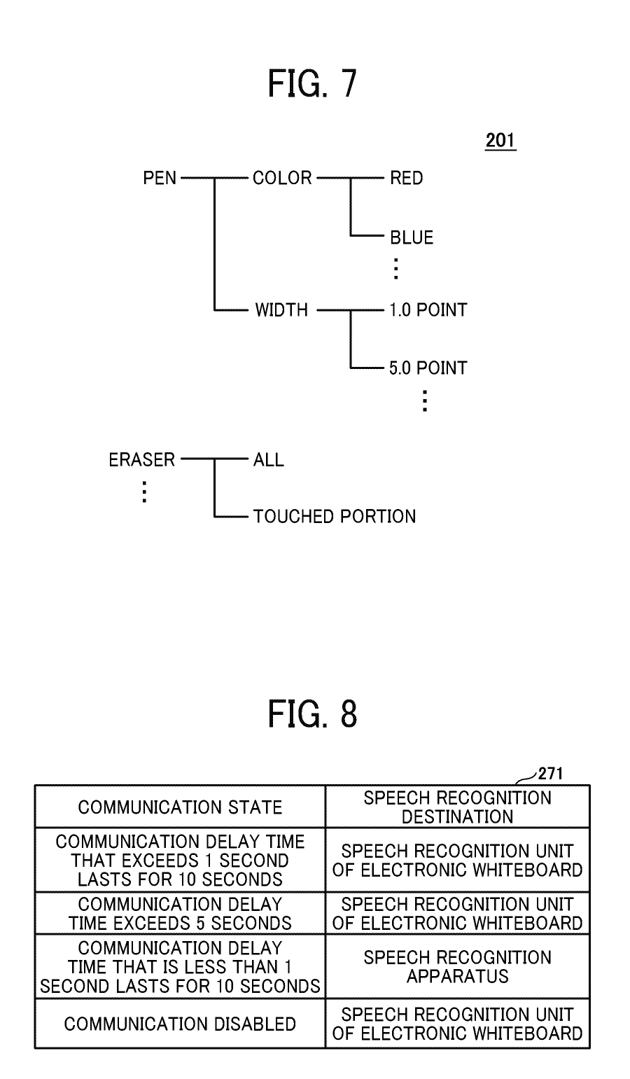

Hereinafter, a description is given of the command database 501 according to the present embodiment, with reference to FIG. 7. FIG. 7 is a diagram illustrating an example of the command database 501.

For example, the command database 501 according to the present embodiment has a tree-like structure, which associates a single word indicating an operation content with a plurality of related words.

In an example of FIG. 5, a word “pen” is associated with a plurality of words “color” and “thickness”, and the word “color” is associated with a plurality of words indicating a color of line, such as “red” and “blue”. In addition, a word “width” is associated with a plurality of words indicating a width of line, such as “1.0 point” and “5.0 points”.

Hereinafter, a description is given of the delay determination table 271, with reference to FIG. 8. FIG. 8 is an illustration for explaining the delay determination table 271 according to the present embodiment.

The delay determination table 271 illustrated in FIG. 8 includes, as information items, a communication state and a speech recognition destination, which are associated with each other. In other words, in the delay determination table 271, the combinations of the communication state and the speech recognition destination are stored.

A value of the item “communication state” is referred to in determining whether or not the network N is congested. A value of the item “speech recognition destination” indicates an apparatus that is to perform speech recognition of audio data collected by the audio collecting unit 210 of the electronic whiteboard 200. In other words, the value of the item “speech recognition destination” indicates a destination to which the audio data is to be output.

In the example of FIG. 8, when the communication delay time exceeding 1 second lasts for 10 seconds or more, when the communication delay time exceeds 5 seconds, and when the communication is not available, a destination to which the audio data is to be output is the speech recognition unit 280 of the electronic whiteboard 200.

Further, in the example of FIG. 8, when the communication delay time of 1 second or less lasts for 10 seconds, a destination to which the audio data is to be output is the speech recognition apparatus 400.

It should be noted that in this disclosure, “when the communication time exceeding 1 second lasts for 10 second more” indicates a case in which the communication delay time exceeding 1 second is obtained 10 consecutive times or more. In other words, in this case the communication time counting unit 265 stores the communication delay time exceeding 1 second for 10 consecutive times or more as the history of communication.

Also, in this disclosure, “when the communication delay time of 1 second or less lasts for 10 seconds” indicates a case in which the communication delay time of 1 second or less is obtained 10 consecutive times. In other words, in this case, the communication time counting unit 265 stores the communication delay time of 1 second or less for 10 consecutive times as the history of communication.

Therefore, as understood from FIG. 8, when the communication delay time is long, speech recognition is performed by the speech recognition unit 280 of the electronic whiteboard 200 itself on the audio data collected in the electronic whiteboard 200.

In other words, according to the present embodiment, it is determined that the network N is congested, when the pattern of communication delay time corresponds to the value of the item “communication state” associated with the speech recognition destination “speech recognition unit of electronic whiteboard” in the delay determination table 271.

Therefore, in the present embodiment, the pattern of communication delay time indicated by the value of the item “communication state” associated with the speech recognition destination “speech recognition unit of electronic whiteboard” in the delay determination table 271 is the predetermined condition to be satisfied to determine that the network N is congested.

The communication delay time is a time period from a time when the electronic whiteboard 200 transmits content data to the server apparatus 300 until a time when the electronic whiteboard 200 receives a notification indicating that storage of the content data has been completed from the server apparatus 300. In other words, the communication delay time is a time period from a time when the electronic whiteboard 200 transmits content data to an external apparatus (other apparatus that communicates with the electronic whiteboard 200) until a time when the electronic whiteboard 200 receives a notification of the completion of storage of content data from the external apparatus.

In another example, the communication delay time is a time period from a time when the electronic whiteboard 200 transmits audio data to the speech recognition apparatus 400 (other apparatus that communicates with the electronic whiteboard 200) until a time when the electronic whiteboard 200 receives text data as a result of speech recognition from the speech recognition apparatus 400.

It should be noted that the predetermined condition based on which a destination to which audio data is to be output is selected is not limited to the example of FIG. 8.

In the present embodiment, for example, when the communication delay time exceeds 1 second, a destination to which audio data is to be output may be switched from the speech recognition apparatus 400, which needs to communicate data via the network, to the speech recognition unit 280 of the electronic whiteboard 200 itself. The combination of the communication delay time and the speech recognition destination in the delay determination table 271 of the present embodiment may be arbitrarily determined by, for example, an administrator of the electronic whiteboard 200.

Hereinafter, a description is given of steps in an operation performed by the information processing system 100 according to the present embodiment, with reference to FIGS. 9A and 9B. FIGS. 9A and 9B are a sequence diagram illustrating an operation performed by the information processing system 100 according to the first embodiment.

A process of step S901 in FIG. 9A corresponds to the process of step S1 in FIG. 1. The processes from step S902 to step S925 correspond to the process of step S2 in FIG. 1. Further, the processes from step S926 to step S945 in FIGS. 9A and 9B correspond to step S3 in FIG. 1. Furthermore, the process of step S4 in FIG. 1 is a process performed in a case in which the load on the network is not so heavy to cause congestion of the network and the communication delay time does not indicate a predetermined pattern. Accordingly, in step S4 in FIG. 1, the same or substantially the same process as the processes from step S901 to step S924 in FIGS. 9A and 6B is performed.

In the information processing system 100 according to the present embodiment, the audio collecting unit 210 acquires audio data, and transfers the acquired audio data to the content conversion unit 230 (S901). Further, the input unit 220 acquires image data or video data, and transfers the acquired image data and video data to the content conversion unit 230 (S902).

The content conversion unit 230 converts the data format of these data received from the audio collecting unit 210 and the input unit 220 according to the set parameters (S903). The content conversion unit 230 transfers the data having the converted format to the transmitter/receiver 240 (S904). The transmitter/receiver 240 transmits content data including the audio data, the image data and the video data to the server apparatus 300 (S905).

Further, the transmitter/receiver 240 transmits an instruction to start counting a communication delay time to the communication time counting unit 265 (S906). In response to this instruction, the communication time counting unit 265 starts counting the communication delay time (S907).

In response to receiving the content data at the transmitter/receiver 320, the server apparatus 300 transfers the content data to the content storage unit 330 (S908) to store the received content data in the content database 310 (S909).

Subsequently, the content storage unit 330 transmits, to the transmitter/receiver 320, a notification indicating that storage of the content data has been completed (S910). The transmitter/receiver 320 transmits this notification to the electronic whiteboard 200 (S911).

In response to receiving this notification, the transmitter/receiver 240 of the electronic whiteboard 200 transmits an instruction to stop counting the communication delay time to the communication time counting unit 265 (S912). In response to receiving this instruction, the communication time counting unit 265 stops counting the communication delay time (S913). The communication time counting unit 265 may hold the measured communication delay time as a history of communication.

In addition, the transmitter/receiver 240 of the electronic whiteboard 200 transmits the audio data acquired by the audio collecting unit 210 to the speech recognition apparatus 400 (S914).

In response to receiving the audio data, the speech recognition apparatus 400 performs speech recognition on the received audio data (S915). The speech recognition apparatus 400 transmits text data, which is a result of the speech recognition, to the electronic whiteboard 200 (S916).

Further, the speech recognition apparatus 400 transmits the text data as the speech recognition result to the server apparatus 300 (S917). In response to receiving the text data at the transmitter/receiver 320, the server apparatus 300 transfers the received text data to the content storage unit 330 (S918). The content storage unit 330 stores this text data in association with the content data stored at S909 in the content database 310 (S919).

In response to receiving the text data from the speech recognition apparatus 400, the transmitter/receiver 240 of the electronic whiteboard 200 transfers the received text data to the command extractor 250 (S920).

In response to receiving the text data, the command extractor 250 refers to the command database 501 to determine whether a command is included in the text data (S921).

When the command extractor 250 determines that a command is not included in the test data in step S921, the operation ends.

When the command extractor 250 determines that a command is included in the text data in the step S921, the command extractor 250 extracts the command (S922), and transfers the extracted command to the command execution unit 260 (S923). In response to receiving this command, the command execution unit 260 executes the command (S924).

Further, the output destination selector 270 of the electronic whiteboard 200 refers to the communication delay time held by the communication time counting unit 265 and the delay determination table 271, to select a destination at which the audio data is to be recognized (a destination to which the audio data is to be output) (S925).

More specifically, the output destination selector 270 determines whether the communication state indicated by the pattern of the communication delay time held by the communication time counting unit 265 satisfies the predetermined condition. The output destination selector 270 selects a destination to which the audio data is to be output based on a result of this determination.

In this example, the communication delay time is a time period from a time when the transmitter/receiver 240 transmits the content data in step S905 until a time when the transmitter/receiver 240 receives the notification indicating that the storage of the content data has been completed in step S911.

When the speech recognition apparatus 400 is selected as the destination at which speech recognition of the audio data is to be performed in step S925, the electronic whiteboard 200 performs normal processing from step S901. The case in which the speech recognition apparatus 400 is selected as the destination at which the speech recognition of the audio data is to be performed, voice data recognition destination corresponds to a case in which the load on the network is not so heavy to cause congestion of the network.

When the speech recognition unit 280 is selected as the destination at which speech recognition of the audio data is to be performed in step S925, the electronic whiteboard 200 performs processes of step S926 and the following steps on content data to be input subsequently.

The processes from step S926 to step S934 in FIGS. 9A and 9B is the same or substantially the same as the processes from step S901 to step S909, except that the measurement of the communication delay time is not performed by steps S 906, S907, S912 and S 913. Accordingly, redundant description thereof is omitted below.

Subsequent to step S934, the content conversion unit 230 of the electronic whiteboard 200 transfers the audio data to the speech recognition unit 280 (S 935). In response to receiving the audio data, the speech recognition unit 280 refers to the dictionary database 502 to perform speech recognition (S936). The speech recognition unit 280 transfers text data, which is a result of the speech recognition, to the command extractor 250 (S937).

Since processes of S938 to S941 are performed in substantially the similar manner as described above referring to S921 to S924, redundant description thereof is omitted below.

Subsequent to step S941, the speech recognition unit 280 of the electronic whiteboard 200 transfers the text data to the transmitter/receiver 240 (S942). The transmitter/receiver 240 transmits the text data to the server apparatus 300 (S943). In the server apparatus 300, the transmitter/receiver 320 transfers the received text data to the content storage unit 330 (S944). The content storage unit 330 stores the received text data in association with the content data stored in step S928 in the content database 310 (S945).

As described above, in the present embodiment, based on the communication delay time between the electronic whiteboard 200 and the server apparatus 300, a destination to which audio data is to be output (a device that is to perform speech recognition on the audio data) is selected.

Therefore, the present embodiment enables to convert audio data to text data without intervening the network, extract a command, and execute the extracted command, when the network is congested, for example.

Accordingly, the present embodiment enables to improve responsiveness to an operation instruction by voice even when the load on the network for communication is heavy, for example.

Further, in the present embodiment, the dictionary update unit 290 periodically updates the dictionary database 502 that is referred to by the speech recognition unit 280 of the electronic whiteboard 200. This improves the accuracy of speech recognition by the speech recognition unit 280 according to the present embodiment closely to the accuracy of speech recognition by the speech recognition apparatus 400.

### Embodiment 2

Hereinafter, a description is given of a second embodiment of the present disclosure with reference drawings. The second embodiment is different from the first embodiment in that the information processing system is communicable with a plurality of speech recognition apparatuses. Therefore, the description of the second embodiment is given of the differences from the first embodiment. The same reference numbers are allocated to the same functions or configurations as those of the first embodiment, and redundant descriptions thereof are omitted below.

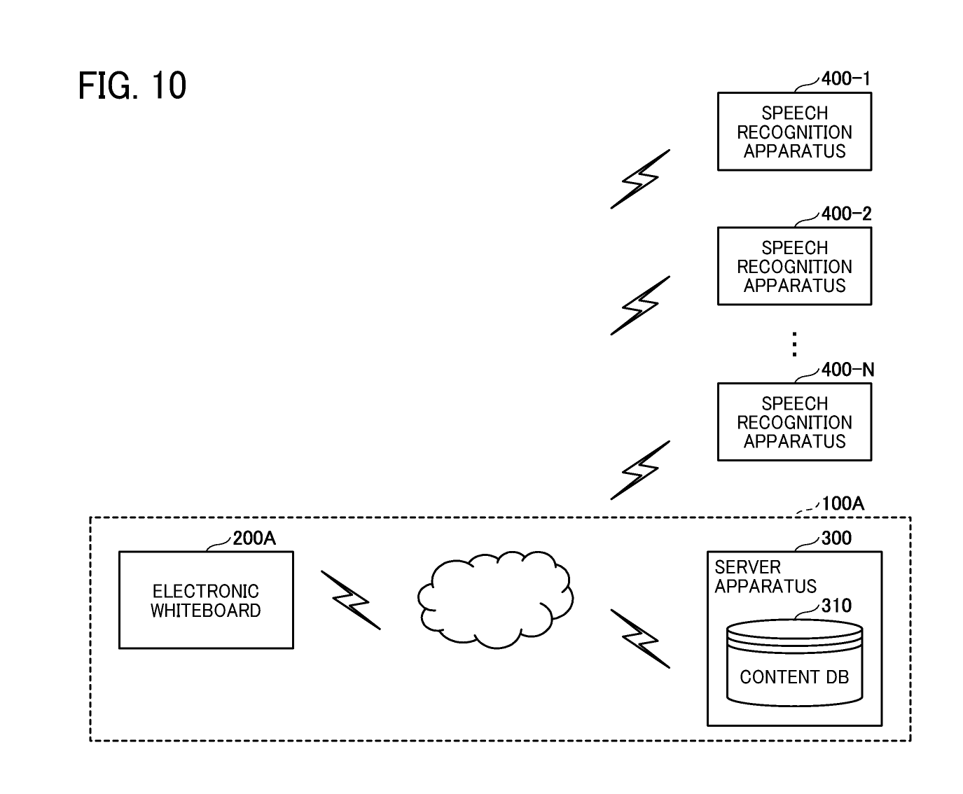

FIG. 10 is a schematic view illustrating an example of a system configuration of an information processing system 100A according to the second embodiment. The information processing system 100A according to the present embodiment includes an electronic whiteboard 200A and the server apparatus 300.

In addition, the information processing system 100A according to the present embodiment is communicable with a plurality of speech recognition apparatuses 400-1, 400-2, . . . , 400-N via the network N.

Each of the plurality of speech recognition apparatuses 400-1, 400-2, . . . , 400-N is a service provided by artificial intelligence, which converts received audio data into text data by a speech recognition function and transmits the text data to the electronic whiteboard 200 or the server apparatus 300.

In addition, according to the present embodiment, the plurality of speech recognition apparatuses 400-1, 400-2, . . . , 400-N may be speech recognition apparatuses corresponding to audio data of different languages, respectively.

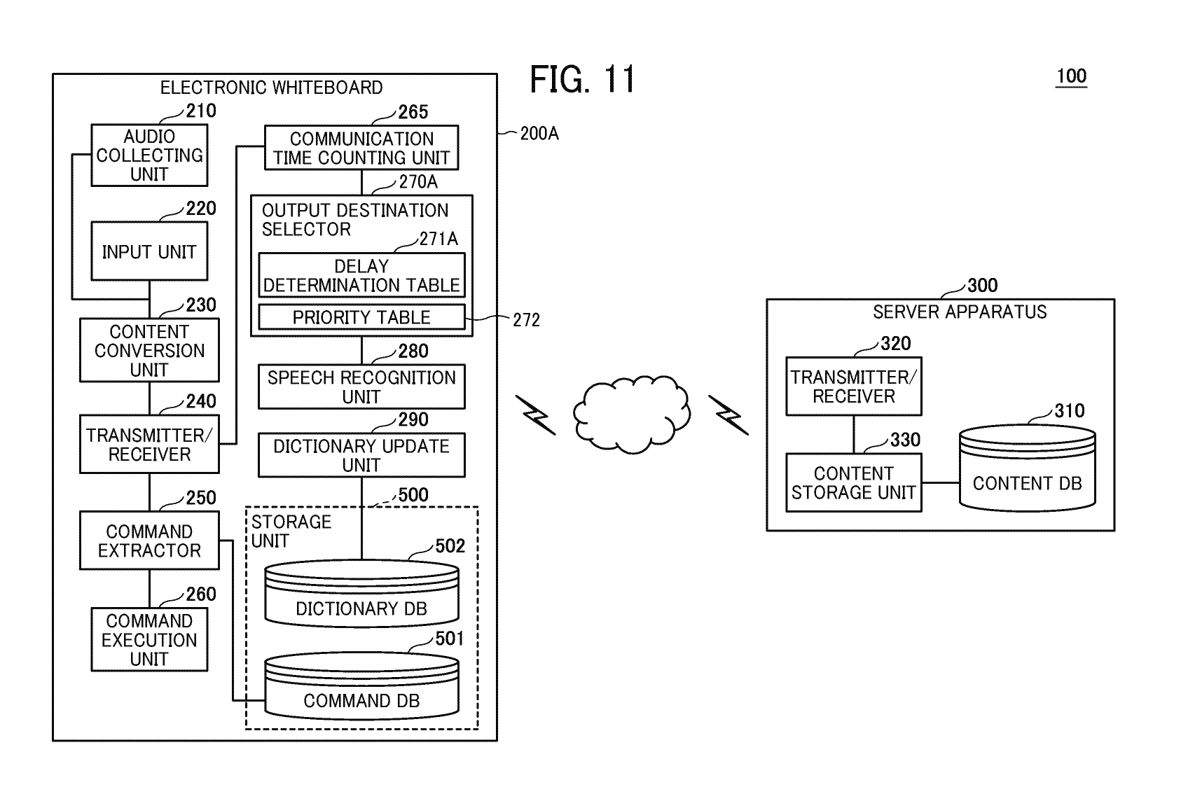

FIG. 11 is a block diagram illustrating functions of each apparatus included in the information processing system 100A according to the second embodiment.

The electronic whiteboard 200A according to the present embodiment includes the audio collecting unit 210, the input unit 220, the content conversion unit 230, the transmitter/receiver 240, the command extractor 250, the command execution unit 260, the communication time counting unit 265, an output destination selector 270A, the speech recognition unit 280, and the dictionary update unit 290.

The output destination selector 270A of the present embodiment includes a delay determination table 271A and a priority table 272. When a state of communication satisfies a predetermined condition, the output destination selector 270A refers to the priority table 272 to select a destination to which the audio data is to be output. Hereinafter, a description is given of the delay determination table 271A and the priority table 272.

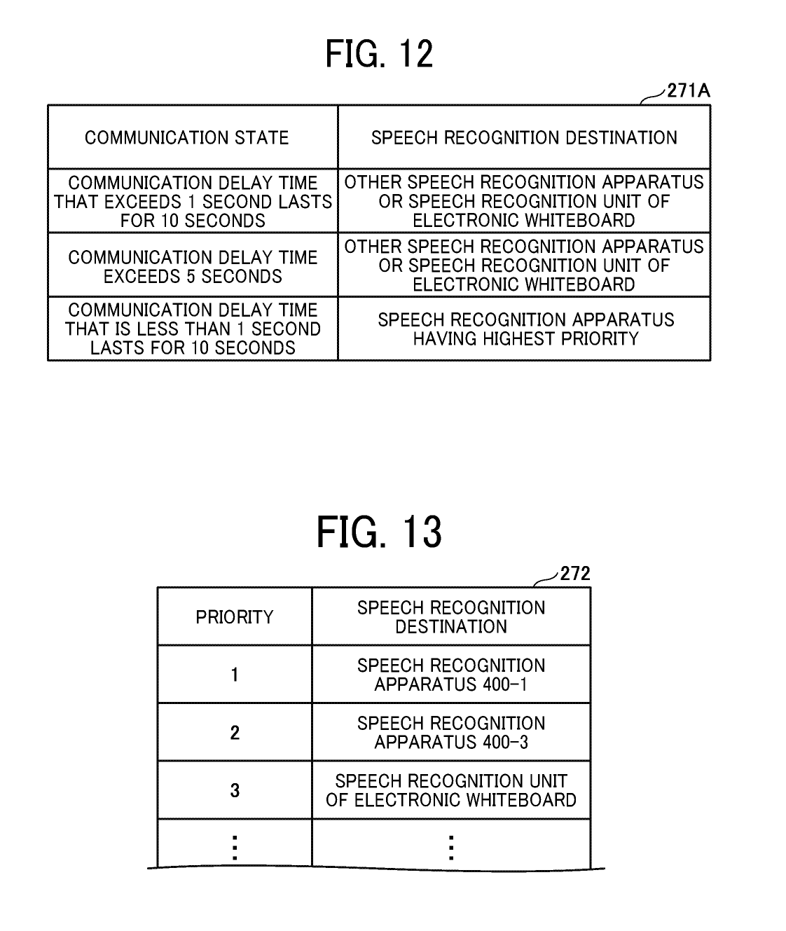

FIG. 12 illustrates an example of the delay determination table 271A according to the second embodiment. In the present embodiment, the priority table 272 may be provided in advance with the output destination selector 270A of the electronic whiteboard 200.

Further, the delay determination table 271A of the present embodiment has “other speech recognition apparatus 400 or speech recognition unit of the electronic whiteboard 200” as a value of the item “speech recognition destination”.

For example, as understood from an example of FIG. 12, when a value of the item “communication state” is “communication delay time exceeds 5 seconds”, a destination at which speech recognition is to be performed is selected from the other speech recognition apparatus 400 and the speech recognition unit 280 of the electronic whiteboard 200. In other words, in the example of FIG. 12, when the pattern of the communication delay time is a pattern “communication delay time exceeds 5 seconds”, the electronic whiteboard 200A determines that the network N is congested.

Further, as understood from the example of FIG. 12, when the value of the item “communication state” is “communication delay time of 1 second or less has lasted for 10 seconds”, the speech recognition apparatus 400 whose priority is highest is selected as a destination at which speech recognition is to be performed. In other words, in the example of FIG. 12, when the pattern of the communication delay time is a pattern “communication delay time of 1 second or less has lasted for 10 seconds”, the electronic whiteboard 200A determines that the network N is not congested.

FIG. 13 illustrates an example of the priority table 272 according to the second embodiment. The priority table 272 according to the present embodiment has a priority and a speech recognition destination as items of information. The priority table 272 associates priorities with the speech recognition destinations.

For example, in the example of FIG. 13, the speech recognition apparatus 400-1 is a speech recognition destination having the highest priority, and the speech recognition apparatus 400-3 is a speech recognition destination having the second highest priority. The speech recognition unit 280 of the electronic whiteboard 200A is a speech recognition destination having the third highest priority.

In this embodiment, priorities may be assigned in order from the speech recognition apparatus 400 having the highest accuracy of speech recognition for a language that is frequently used in the electronic whiteboard 200A, for example. In addition, the priorities of the priority table 272 according to the present embodiment may be updated periodically, for example. In this case, connection tests are performed periodically on a plurality of speech recognition apparatuses 400 that are communicable with the electronic whiteboard 200A, for example, and the priorities in the priority table 272 may be updated according to the result of the connection test.

The output destination selector 270A according to the present embodiment refers to the delay determination table 271A and the priority table 272 to select a destination to which audio data is to be output, when the communication delay time between the electronic whiteboard 200A and the speech recognition apparatus 400 that is firstly connected to the electronic whiteboard 200A satisfies a predetermined condition.

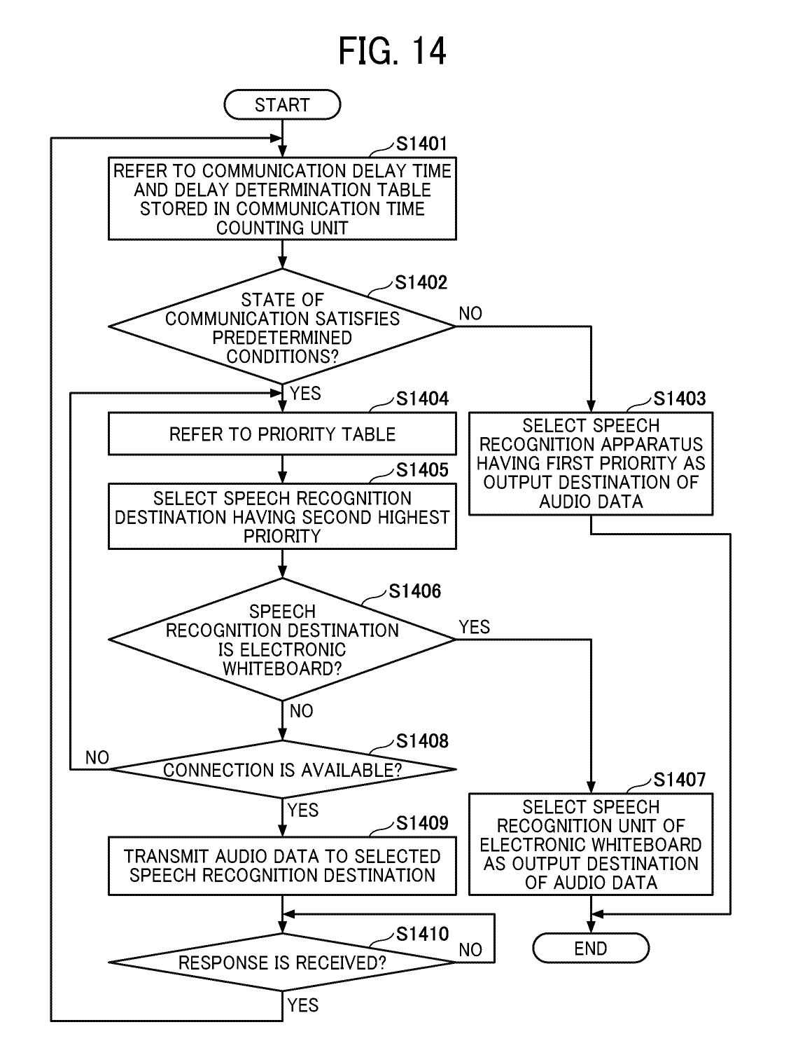

Hereinafter, a description is given of steps in an operation performed by the output destination selector 270A according to the present embodiment, with reference to FIG. 14. FIG. 14 is a flowchart illustrating steps in an operation performed by the output destination selector 270A according to the second embodiment.

FIG. 14 illustrates an operation by the output destination selector 270A for selecting a destination at which speech recognition is to be performed (a destination to which audio data is to be output) in the step S925 of FIG. 9A.

In the electronic whiteboard 200A according to the present embodiment, when the communication time counting unit 265 measures the communication delay time, the output destination selector 270A refers to the communication delay time held by the communication time counting unit 265 and the delay determination table 271A (S 1401) to determine whether the communication state satisfies a predetermined condition (S1402).

When the output destination selector 270A determines that the communication state does not satisfy the predetermined condition (S1402: NO), the output destination selector 270A refers to the priority table 272 to select the speech recognition apparatus 400 having the highest priority as a destination to which audio data is to be output (S1403). Then, the operation ends. In this case, the electronic whiteboard 200A performs normal processing from step S901.

By contrast, when the output destination selector 270A determines that the communication state satisfies the predetermined condition (S1402: YES), the output destination selector 270A refers to the priority table 272 (S 1404). Subsequently, the output destination selector 270A selects the speech recognition destination having the second highest priority in the priority table 272 (S1405).

Subsequently, the output destination selector 270A determines whether the selected speech recognition destination is the speech recognition unit 280 of the electronic whiteboard 200A (S1406). When the selected speech recognition destination is the speech recognition unit 280 of the electronic whiteboard 200 (S1406: YES), the output destination selector 270A selects the speech recognition unit 280 of the electronic blackboard 200A as a destination to which the audio data is to be output (S1407). Then, the processing ends.

When the selected speech recognition destination is not the speech recognition unit 280 of the electronic whiteboard 200A (S1406: NO), the output destination selector 270A determines whether or not connection with the selected speech recognition destination is available (S1408). More specifically, the output destination selector 270A transmits a specific signal to the selected apparatus as the speech recognition destination. The output destination selector 270A determines whether the connection is available based on which whether a response signal is received from the selected apparatus to which the specific signal has been transmitted.

When the connection is not available (S1408: NO), the operation by the output destination selector 270A returns to step S1404.

When the connection is available (S 1408: YES), the output destination selector 270A controls the transmitter/receiver 240 to transmit audio data to the selected speech recognition destination (S 1409).

Subsequently, the output destination selector 270A determines whether the transmitter/receiver 240 has received a response indicating that text data has been received from the speech recognition destination (S1410). When the transmitter/receiver 240 receives no response (S1410: NO), the output destination selector 270A waits until receiving a response.

When the transmitter/receiver 240 receives the response (S1410: YES), the operation by the output destination selector 270A returns to S1401.

As described above, according to the present embodiment, when the electronic whiteboard 200A is communicable with a plurality of speech recognition apparatuses 400, a destination to which audio data is to be output according to a predetermined priority order.

According to embodiments of the present disclosure, responsiveness to an operation instruction by voice is improved.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing apparatus communicable with a speech recognition apparatus via a network, the information processing apparatus comprising:
circuitry to
implement a speech recognition function that performs speech recognition on audio data collected by an audio collecting device; and
select, as a destination to which the audio data is to be output, one of the speech recognition apparatus and the speech recognition function implemented by the circuitry, based on a state of communication between the information processing apparatus and an external system connected to the information processing apparatus via the network.

2. The information processing apparatus of claim 1, wherein
the external system includes an external apparatus in which the content data is stored and the speech recognition apparatus.

3. The information processing apparatus of claim 2, wherein
the circuitry further counts, as a communication delay time between the information processing apparatus and the external apparatus, a time period from a time when the information processing apparatus transmits the content data to the external apparatus until a time when the information processing apparatus receives a notification indicating that storage of the content data has been completed from the external apparatus.

4. The information processing apparatus of claim 3,
wherein the circuitry selects the speech recognition apparatus as the destination to which the audio data is to be output when the state of communication indicated by the communication delay time satisfies a predetermined condition.

5. The information processing apparatus of claim 4, wherein
the speech recognition apparatus includes a plurality of speech recognition apparatuses communicable with the information processing apparatus via the network, and
when the state of communication satisfies a predetermined condition, the circuitry selects one of the plurality of speech recognition apparatuses and the speech recognition function implemented by the circuitry as the destination to which the audio data is to be output, based on priority orders between the plurality of speech recognition apparatuses and the speech recognition function implemented by the circuitry.

6. The information processing apparatus of claim 2, further comprising:
a memory to store a dictionary database referred by the circuitry to implement the speech recognition function, wherein
the circuitry further updates the dictionary database when transmission and reception of the content data is not performed.

7. The information processing apparatus of claim 2, wherein the circuitry further:
refers to a memory storing commands for the information processing apparatus to extract a command including an operation content for the information processing apparatus from text data, which is a result of the speech recognition of the audio data; and
controls the information processing apparatus to execute the command that is extracted.

8. The information processing apparatus of claim 2, wherein the text data, which is the result of the speech recognition by the speech recognition function implemented by the circuitry, is stored in the external apparatus in association with the content data.

9. An information processing method performed by an information processing apparatus communicable with a speech recognition apparatus via a network, the information processing method comprising:
implementing a speech recognition function that performs speech recognition on audio data collected by an audio collecting device; and
selecting, as a destination to which the audio data is to be output, one of the speech recognition apparatus and the speech recognition function, based on a state of communication between the information processing apparatus and an external system connected to the information processing apparatus via the network.

10. A computer program product embedded on a non-transitory computer readable medium comprising:
a first code segment executable to implement a speech recognition function that performs speech recognition on audio data collected by an audio collecting device; and
a second code segment executable to select, as a destination to which the audio data is to be output, one of the speech recognition apparatus and the speech recognition function, based on a state of communication between the information processing apparatus and an external system connected to the information processing apparatus via the network.
